(19) United States
(12) Patent Application Publication
(10) Pub. No.: US 2015/0371255 A1
(43) Pub. Date: Dec. 24, 2015

(54) SYSTEM OF AUTOMATIC SELECTION AND VALIDATION OF THE OPTIMAL COUPONS COMBINATION

(71) Applicants: Konstantin REBIKOV, Kemerovo (RU); Andrey MIKHAYLISHIN, Kemerovo (RU); Sergey ZHDANOV, Kemerovo (RU)

(72) Inventors: Konstantin REBIKOV, Kemerovo (RU); Andrey MIKHAYLISHIN, Kemerovo (RU); Sergey ZHDANOV, Kemerovo (RU)

(21) Appl. No.: 14/746,940

(22) Filed: Jun. 23, 2015

Related U.S. Application Data
(60) Provisional application No. 62/016,165, filed on Jun. 24, 2014.

(51) Int. Cl. G06Q 30/02

(52) U.S. Cl. CPC G06Q 30/0225; G06Q 30/0238

(57) ABSTRACT

The present invention is in the field of coupon management and redemption for customers at the point of sale. The goal of the present invention is to provide a streamlined and automated way to determine the best award according to business logic or rules as chosen to apply by a cashier or customer available to a customer at a point of sale based upon the coupons and/or discounts available to the customer that either the customer presents or that the customer has uniquely associated with their customer identifier on a processing server.

### REFERENCE TO RELATED APPLICATIONS

The present invention claims priority to U.S. provisional application No. 62/016,165 filed on Jun. 24, 2014.

### BACKGROUND OF THE INVENTION

1. Field of the Invention

This invention is in the field of coupon management and redemption for customers at the point of sale.

2. Background Art

The conventional mechanism for clearing coupons on point of sale terminal generally proceeds along the following scenario. First, the customer presents a set of coupons that the customer is willing to redeem to the cashier. The cashier scans or enters the coupons thus redeeming the coupons. The cashier and/or software at the point of sale calculates the discount to be given to the customer. It is generally up to the cashier to make sure two mutually exclusive coupons are not used at once. The total cost to the customer is calculated taking into account the applied discounts from the redeemed coupons.

US 20050234771 A1 Register et al. (hereinafter “Register”) is a prior art patent application for coupon distribution and management, particularly as an in-store couponing system. The prior art patent application uses an intelligent in-store marketing system involving customer tracking within store, customer purchase tracking, coupon distribution (whether digital, paper, in store, or via in-store media system). The system is based upon providing coupons to encourage customers to buy items that either need to be sold soon or for seasonal and other promotional aspects. The Register patent application does not contemplate the idea of a couponing system in which the system automatically optimizes the coupons available to the customer.

U.S. Pat. No. 7,783,532 B2 Hsu et al. (hereinafter “Hsu”) is a prior art patent application for e-couponing. This prior art invention uses a computer system to track coupons available to a customer across multiple retail locations or entities. The e-couponing system allows the for the redemption and cancellation of coupons. The e-couponing system is bound to the customer having a loyalty card or customer identifier. The Hsu patent also does not contemplate a system for automatically optimizing the coupons available to or being redeemed by the customer.

US 20020143612 A1 Barik et al. (hereinafter “Barik”) is a prior art patent application for e-couponing. This prior art invention determines a combination of coupons redeemable with a retailer including whether or not such coupons are mutually exclusive. The Barik patent application is limited to e-coupons and does not contemplate a system for automatically retrieving coupons for a customer based upon a unique customer identifier.

US 20130024371 A1 Hariramani et al. (hereinafter “Hariramani”) is a prior art patent application. This prior art invention determines which out of a set of credit cards or store cards a customer has should be used when making purchase based upon the reward features of that card. The Hariramani patent application does not contemplate a system for automatically optimizing the coupons available to or being redeemed by the customer.

### SUMMARY OF THE INVENTION

The present invention is a coupon system that operates in two manners in order to optimize the award available to a customer. One form is where a customer has brought their own coupons and is attempting to use their coupons at the point of sale. Coupons and the offers they embody can be mutually exclusive allowing a customer to not use one coupon or offer with another. The present invention allows all coupons brought by the customer to be scanned or otherwise input into the point of sale terminal and then automatically calculates which group of coupons can be used together to provide the customer with the best award on their present purchase available to the customer based upon business. The customer can then save any non-redeemed coupons for later use. The present invention can also sort between best award but may also be configured to prioritize the use of awards/coupons based on business logic. Business logic includes such option as using awards/discounts based on expiration date, maximum benefit to buyer, maximum number of coupons/awards redeemable, maximum discount, maximum number of rewards points a customer could accrue, and more, etc. If a cashier is present, or if the customer is using an automated checkout the point of sale terminal user approves the redemption of the automatically selected coupons. Those coupons are redeemed and marked in a central database and are no longer valid, or they can simply be surrendered to a cashier for disposal.

In the second form the customer is identified by a unique identifier such as, but not limited to: name, phone number, loyalty card, store card, email address, customer number, reward number, or other such identifying information as the business may use to identify customers. The unique identifier is used to contact a coupon database via a network in order to determine what coupons or awards are available to the customer through their unique identifier. The coupon system then performs a calculation as to which combination of coupons provides the greatest award to the customer. The cashier or customer, if in an automated checkout, approves the use of the coupons or discounts at the point of sale. The coupons or discounts are then marked as used in the coupon database and cannot be redeemed by the customer again, unless it is a reusable coupon.

In both cases the coupon system determines the greatest number of usable coupons from the coupon set, which the customer brought with them or that which is available from the coupon database, based upon the business logic being applied at time of purchase. The business logic can be selected by the cashier if present or by the customer if at an automated or online checkout. The coupon system determines the greatest number of usable coupons based upon the composition of the present purchase check of items the customer is buying in conjunction with either the coupons brought by the customer or the available coupons stored on the coupon database.

The coupon system automatically validates the selected set of coupons. The system automatically calculates the award based on the purchase items and pricing information and the matched set of coupons, and the point of sale terminal operator controls whether the award is accepted and the coupons are redeemed.

### BRIEF DESCRIPTION OF THE DRAWINGS

The present invention will now be discussed in further detail below with reference to the accompanying figures in which:

FIG. 1 is a diagram showing the steps of one embodiment of the present invention.

FIG. 2 is a diagram showing the steps of another embodiment of the present invention.

FIG. 3 is a diagram showing the steps of another embodiment of the present invention.

FIG. 4 is a diagram showing the steps of another embodiment of the present invention.

FIG. 5 is a diagram showing the systems needed to carry out the present invention.

FIG. 6 is a diagram showing the steps of another embodiment of the present invention.

### DETAILED DESCRIPTION OF THE PREFERRED EMBODIMENTS

In the following detailed description of a preferred embodiment of the invention, reference is made to the accompanying drawings that form a part hereof, and in which are shown by way of illustration a specific embodiment in which the invention may be practiced. It is understood that other embodiments may be utilized and structural changes may be made without departing from the scope of the present invention.

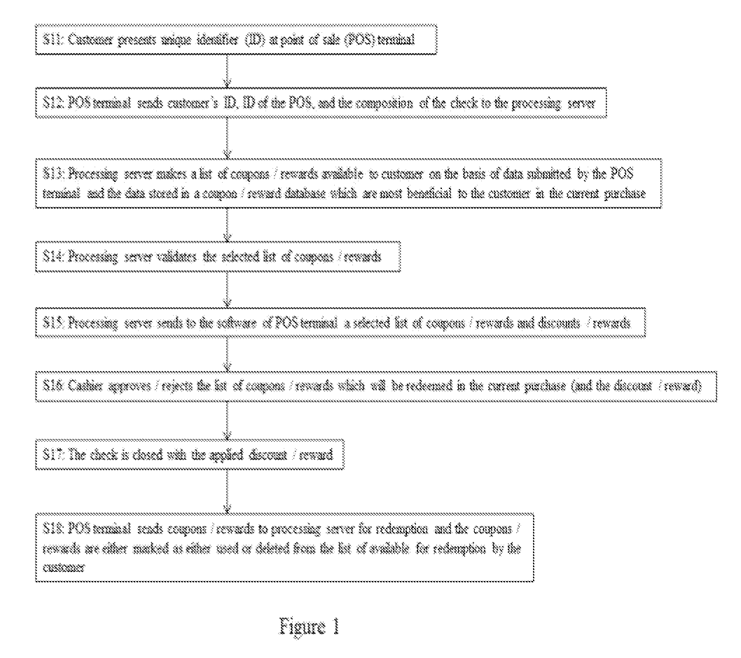

FIG. 1 shows one embodiment of the present invention. The method and system of the present invention follow the following steps. Step 11: Customer presents unique identifier (ID) at point of sale (POS) terminal. Step 12: POS terminal sends customer's ID, ID of the POS, and the composition of the check to the processing server. Step 13: The processing server makes a list of coupons available to customer on the basis of data submitted by the POS terminal and the data stored in a coupon database which are most beneficial to the customer in the current purchase. Step 14: The processing server validates the selected list of coupons. Step 15: The processing server sends to the software of POS terminal a selected list of coupons and discounts. Step 16: The cashier approves or rejects the list of coupons which will be redeemed in the current purchase (and the total discount). Step 17: The check is closed with the applied discount. Step 18: The POS terminal sends coupons to processing server for redemption and the coupons are either marked as either used or deleted from the list of available for redemption by the customer.

A unique identifier can be, but not limited to a name, a phone number, a loyalty card, a store card, an email address, a customer number, a reward number, a coupon number, or other such identifying information as the business may use to identify customers. The processing server can be any computer or computational device capable of performing award comparisons, date/expiration analysis, analysis based upon other business logic parameters, analysis based on customer's choice, or business rules, and capable of matching coupons or awards to the items on the customer's present purchase. Business logic and rules include such option as using awards based on expiration date, maximum benefit to buyer, maximum number of coupons/awards redeemable, maximum number of rewards points a customer could accrue, and more, etc. The processing server may be a separate server from the point of sale terminal and connected to via a network connection or the functions of the processing server can be carried out on the point of sale terminal. The processing server compares the list of items on the customer's check with the coupons available to the customer and determines what is the greatest award that is available to the customer while taking into account if any of the coupons are mutually exclusive and cannot be used together. Coupons should be validated in order to prevent use of fraudulent coupons or reusing previously used coupons. For the purposes of network communication any form of network connection whether wired, wireless, or other form of communication can be used between the POS terminal and the processing server. Also it should be noted that the POS terminal and processing server can have their functions performed in a single software program and/or on a single electronic system.

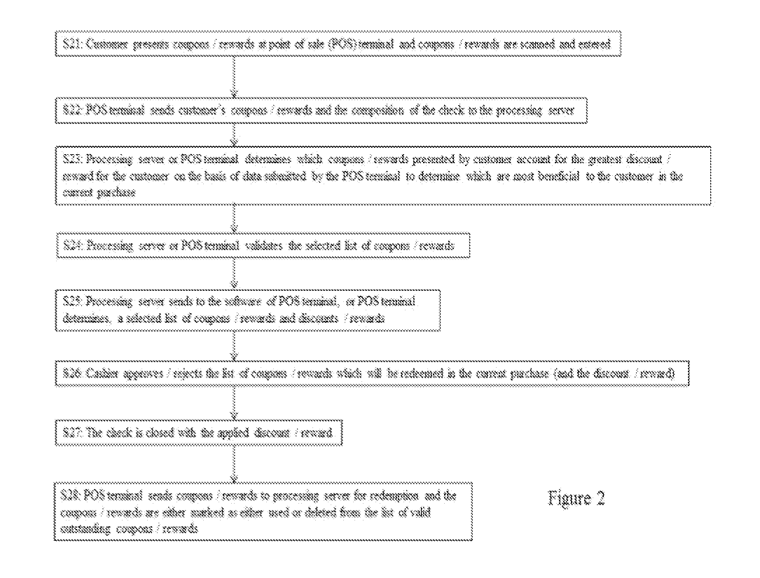

FIG. 2 shows one embodiment of the present invention. The method and system of the present invention follow the following steps. Step 21: Customer presents coupons at point of sale (POS) terminal and coupons are scanned and entered. Step 22: POS terminal sends customer's coupons and the composition of the check to the processing server. Step 23: The processing server or POS terminal determines which coupons presented by customer account for the greatest discount for the customer on the basis of data submitted by the POS terminal to determine which are most beneficial to the customer in the current purchase. Step 24: The processing server or POS terminal validates the selected list of coupons. Step 25: Processing server sends to the software of POS terminal, or POS terminal determines, a selected list of coupons and discounts. Step 26: Cashier approves/rejects the list of coupons which will be redeemed in the current purchase (and the total discount). Step 27: The check is closed with the applied discount. Step 28: POS terminal sends coupons to processing server for redemption and the coupons are either marked as either used or deleted from the list of valid outstanding coupons.

The coupons presented by customer can be scanned via barcode, image, or any other scanning method. The coupons presented could be stored on a cell phone or other digital device and be scanned in. Also coupons can have numbers or identifiers manually entered. The selected coupons and awards are chosen based upon their ability to be used together so that they are not mutually exclusive or limited in such a way that the coupons cannot be used together. Awards include but are not limited to: discounts, other goods, additional amounts of the same goods, bonus points, new coupons, etc. If the selected list does not include all coupons presented at the point of sale then the point of sale terminal will provide notification, visual and/or audio, as to which of the coupons are to be redeemed at the present time and which ones should be rejected.

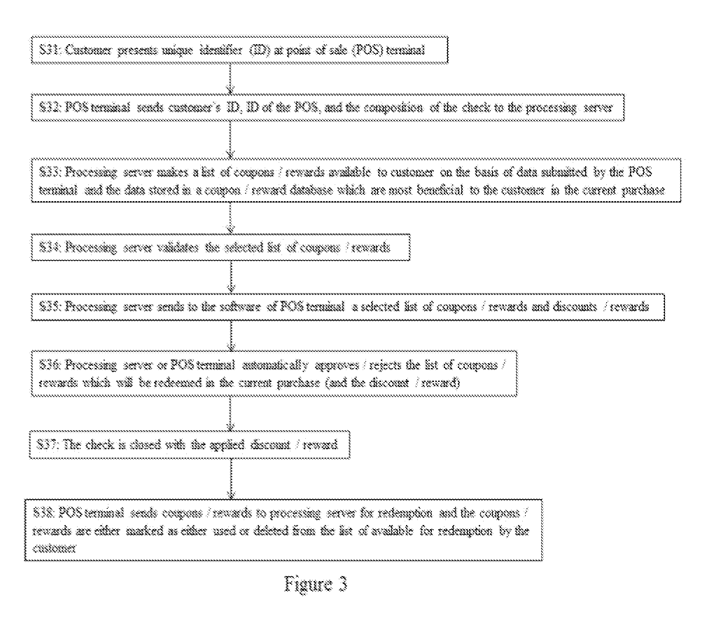

FIG. 3 shows one embodiment of the present invention. The method and system of the present invention follow the following steps. Step 31: Customer presents unique identifier (ID) at point of sale (POS) terminal. Step 32: POS terminal sends customer's ID, ID of the POS, and the composition of the check to the processing server. Step 33: Processing server makes a list of coupons available to customer on the basis of data submitted by the POS terminal and the data stored in a coupon database which are most beneficial to the customer in the current purchase. Step 34: Processing server validates the selected list of coupons. Step 35: Processing server sends to the software of POS terminal a selected list of coupons and discounts. Step 36: Processing server or POS terminal automatically approves/rejects the list of coupons which will be redeemed in the current purchase (and the discount). Step 37: The check is closed with the applied discount. Step 38: POS terminal sends coupons to processing server for redemption and the coupons are either marked as either used or deleted from the list of available for redemption by the customer.

In the immediately preceding and immediately following embodiment of the invention the invention is modified for automatic approval of the award without input by a cashier so that the invention can be used in the current automated checkout lines.

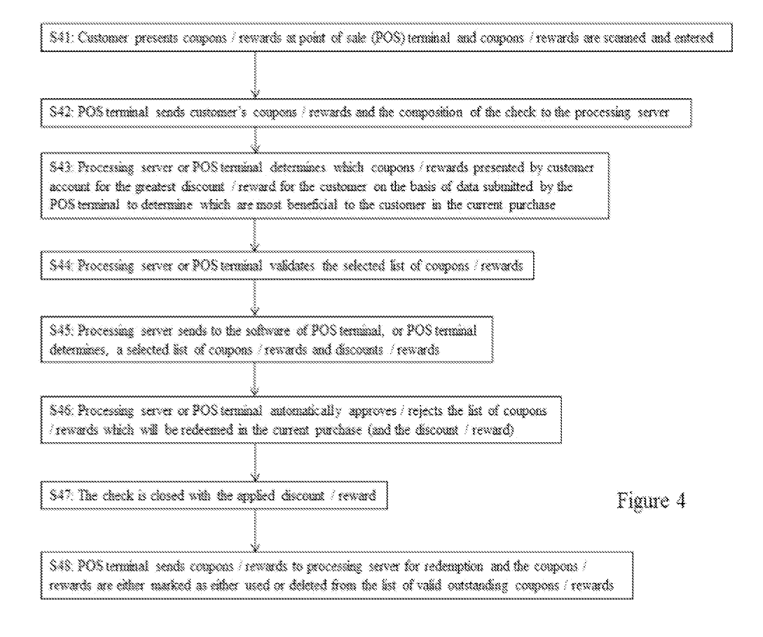

FIG. 4 shows one embodiment of the present invention. The method and system of the present invention follow the following steps. Step 41: Customer presents coupons at point of sale (POS) terminal and coupons are scanned and entered. Step 42: POS terminal sends customer's coupons and the composition of the check to the processing server. Step 43: Processing server or POS terminal determines which coupons presented by customer account for the greatest discount for the customer on the basis of data submitted by the POS terminal to determine which are most beneficial to the customer in the current purchase. Step 44: Processing server or POS terminal validates the selected list of coupons. Step 45: Processing server sends to the software of POS terminal, or POS terminal determines, a selected list of coupons and discounts. Step 46: Processing server or POS terminal automatically approves/rejects the list of coupons which will be redeemed in the current purchase (and the discount). Step 47: The check is closed with the applied discount. Step 48: POS terminal sends coupons to processing server for redemption and the coupons are either marked as either used or deleted from the list of valid outstanding coupons.

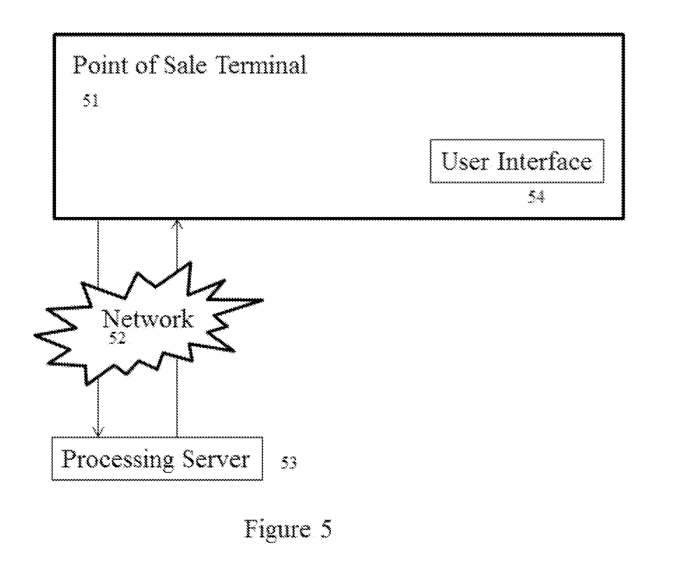

FIG. 5 shows a block diagram of the devices that are involved in the present invention. There is a point of sale terminal 51 with which the customer and/or cashier interact with. The point of sale terminal 51 has a user interface 54 that can be audio, visual, a combination thereof, or some other manner of conveying information to the customer and/or cashier. When the point of sale terminal 51 and processing server 53 are independently hosted they communicate through a network 52. For the purposes of network communication any form of network connection whether wired, wireless, or other form of communication can be used between the POS terminal and the processing server. Also it should be noted that the POS terminal and processing server can have their functions performed in a single software program and/or on a single electronic system.

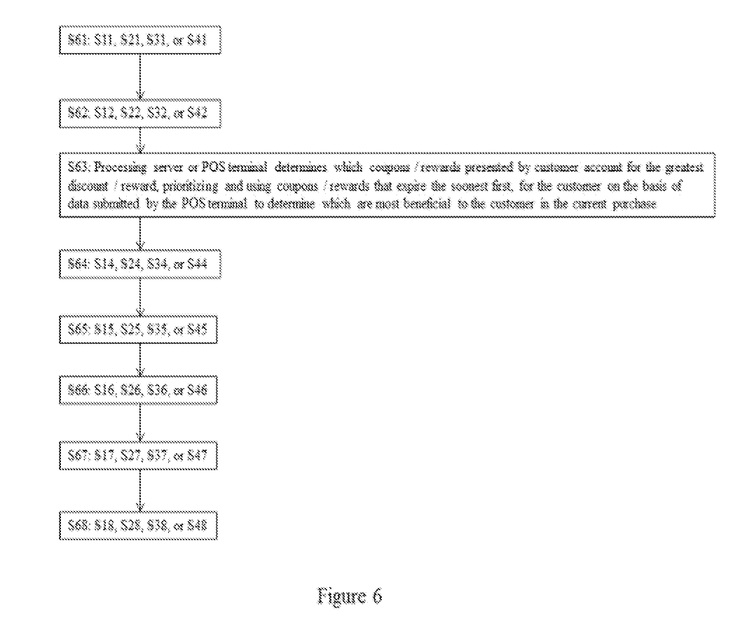

FIG. 6 shows one embodiment of the present invention. The method and system of the present invention follow the following steps. Step 61: any of the following Step 11, Step 21, Step 31, or Step 41. Step 62: The next corresponding Step 12, Step 22, Step 32, or Step 42. Step 63: The processing server or POS terminal determines which coupons presented by customer account for the greatest discount, prioritizing and using coupons that expire the soonest first, for the customer on the basis of data submitted by the POS terminal to determine which are most beneficial to the customer in the current purchase. Step 64: The next corresponding Step 14, Step 24, Step 34, or Step 44. Step 65: The next corresponding Step 15, Step 25, Step 35, or Step 45. Step 66: The next corresponding Step 16, Step 26, Step 36, or Step 46. Step 67: The next corresponding Step 17, Step 2 Step 37, or Step 47. Step 68: The next corresponding Step 18, Step 28, Step 38, or Step 48.

A customer may desire to redeem coupons based upon which coupons expire sooner rather than the greatest discount available to them at the time of purchase. This is especially true for customers that frequent a business on a daily, weekly, or monthly basis. This option being available allows the customer to best use their coupons over time rather than in a single transaction. This also helps encourage customers to purchase from a business on a more frequent basis so as to maximize their award over a prolonged period of time instead of in a single transaction.

If the user has nomenclature coupons and nomenclature coupons are in the parameter that were passed in with a software of POS terminal (List of coupons specified manually), the selection of the most advantageous coupon (combination of coupons) is carried out from the “nomenclature” coupons of the customer and “nomenclature” coupons that were specified and transferred from the POS terminal. A nomenclature coupon is a coupon that specifies a specific item by brand name, a nomenclature coupon would identify an item by the trademark that it is sold under rather than as a group or type of item or a net discount across an entire purchase. Moreover, the scope of the Offer must have the meaning: only on the products in stocks. “Nomenclature” in this case means belonging to the entity where the service occurs. The result of the algorithm is the longest combination of coupons that is compatible with each other, meaning non-mutually exclusive, and it is consisted of “nomenclature” coupons of the user that were transmitted from the POS terminal. If the user does not have “nomenclature” coupons, and they have not been transferred by POS terminal, but just a set of coupons has been transferred, the result of the algorithm is a list of coupons transferred from the POS terminal. In other cases, the result of the algorithm is a list of coupons with a maximum value of benefits.

The above method can be implemented as software that is on a non-transient computer readable medium containing program instructions to perform the above disclosed system and method of providing an optimal coupon combination for a customer based on the business logic, business rules, or customer choice being applied at the point of sale during the present purchase.

What is claimed is:

1. A method for generating the optimal combination of coupons, comprising:
a. customer arrives at point of sale;
b. determining coupons and/or awards available to the customer;
c. automatically determining the maximum award available to the customer based upon items on customer's purchase and coupons and/or awards available to the customer, store identification, a user profile associated with the customer, a customer's purchase history, or collected bonus points, and creating a selected list of coupons or awards;
d. validating the selected list of coupons and/or awards;
e. approving the selected list of coupons and/or awards;
f. finishing the transaction and providing a paper receipt or e-receipt;
g. redeeming customer's coupons and/or awards so that they are marked as redeemed so that the now used coupons and/or awards cannot be used again.

2. The method for generating the optimal combination of coupons of claim 1, wherein the point of sale is a customer checkout attended by a cashier.

3. The method for generating the optimal combination of coupons of claim 1, wherein the point of sale is an automated customer checkout.

4. The method for generating the optimal combination of coupons of claim 1, wherein the point of sale is an online or web based checkout.

5. The method for generating the optimal combination of coupons of claim 1, wherein determining coupons and/or awards available to the customer is based on physical or digital coupons and/or discounts provided by the customer.

6. The method for generating the optimal combination of coupons of claim 1, wherein determining coupons and/or awards available to the customer is based upon a point of sale terminal communicating with a processing server to determine what coupons and/or awards are available to the customer based upon the customer providing a unique customer identifier.

7. The method for generating the optimal combination of coupons of claim 6, wherein the processing server contains a list of coupons and/or awards available and tracks what coupons and/or awards are currently available to an individual customer.

8. The method for generating the optimal combination of coupons of claim 6, wherein the processing server and the point of sale terminal communicate over a wired or wireless network.

9. The method for generating the optimal combination of coupons of claim 6, redeeming customer's coupons and/or awards so that they are marked as redeemed and can no longer be used in any transaction but are still stored in association with the unique customer identifier, the customer may later view redeemed coupons and/or awards in a history of redeemed coupons/awards.

10. The method for generating the optimal combination of coupons of claim 1, wherein the automatically determining the maximum award available to the customer based upon items on customer's present purchase and coupons and/or awards available to the customer and creating a selected list of coupons or awards is based on business logic or rules selected by a cashier or the customer.

11. The method for generating the optimal combination of coupons of claim 10, wherein the business logic or rules include: using awards based on expiration date, maximum benefit to buyer, maximum number of coupons/awards redeemable, or maximum number of rewards points a customer could accrued.

12. The method for generating the optimal combination of coupons of claim 1, wherein the automatically determining the maximum award available to the customer based upon items on customer's present purchase and coupons and business logic or rules selected by a cashier or the customer.

13. The method for generating the optimal combination of coupons of claim 12, wherein the business logic or rules include: using awards based on expiration date, maximum benefit to buyer, maximum number of coupons awards redeemable, or maximum number of rewards points a customer could accrued.

14. The method for generating the optimal combination of coupons of claim 1, wherein the validating the selected list of coupons and/or discounts automatically checks the coupon and/or award available to the customer against a database of known valid coupons and/or awards so as to prevent fraudulent use of a coupon and/or discount.

15. A non-transient computer readable medium containing program instructions for causing a computer to perform the method for generating the optimal combination of coupons, comprising:
a. customer arrives at point of sale;
b. determining coupons and/or awards available to the customer;
c. automatically determining the optimal award available to the customer based upon items on customer's present purchase, coupons, and/or awards available to the customer, store identification, a user profile associated with the customer, a customer's purchase history, or collected bonus points, and creating a selected list of coupons or discounts;
d. validating the selected list of coupons and/or awards;
e. approving the selected list of coupons and/or awards;
f. finishing the transaction and providing a paper receipt or e-receipt;
g. redeeming customer's coupons and/or discounts so that they are marked as redeemed so that the now used coupons and/or discounts cannot be used again.
